(19) United States
(12) Patent Application Publication
(10) Pub. No.: US 2026/0086705 A1
(43) Pub. Date: Mar. 26, 2026

(54) Artificial Intelligence Function Management Platform

(71) Applicant: Zoom Communications, Inc., San Jose, CA (US)

(72) Inventors: Jingjing Chen, Hefei (CN); Zheng Chen, Bellevue, WA (US); Pengcheng He, Redmond, WA (US); Xuedong David Huang, Yarrow Point, WA (US); Gareth Paul Jones, Novato, CA (US); Yaling Song, Hangzhou (CN); Fengcai Sun, Hangzhou (CN); Bo Yan, Sammamish, WA (US); Haoming Zhong, Hangzhou (CN)

(21) Appl. No.: 18/898,003

(22) Filed: Sep. 26, 2024

(51) Int. Cl. G06F 3/0486

(52) U.S. Cl. CPC G06F 3/0486

(57) ABSTRACT

An artificial intelligence (AI) function management platform receives a request to create an AI agent and, in response, provides a graphical user interface configured to render a studio environment for creating the AI agent. The studio environment includes a drag-and-drop visual workflow builder for connecting operations across multiple functional components of a set of available functional components. The platform receives, via the studio environment, user input indicative of at least one AI component of the set of available functional components and at least one operation for performance by the at least one AI component. The platform generates the AI agent based on the user input and deploys the AI agent to a runtime environment.

### FIELD

This disclosure generally relates to an artificial intelligence (AI) system, and, more specifically, to an AI function management platform for creating and deploying custom AI agents.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of an artificial intelligence (AI) system for processing user requests associated with software services of a software platform.

FIG. 5 is a block diagram illustrating a system for managing AI functions.

FIG. 6 illustrates another block diagram of a system for managing AI functions.

FIG. 7 illustrates another example of an AI function management system.

FIG. 8 illustrates a studio environment for creating and managing AI agents.

FIG. 9 illustrates an example of a workflow builder specifically designed for creating an AI agent for meeting summarization.

FIG. 10 illustrates a testing interface for an AI function management platform.

FIG. 11 illustrates a deployment interface for an AI function management platform.

FIG. 12 is a flowchart of an example of a technique for creating and deploying an AI agent.

### DETAILED DESCRIPTION

Enterprise entities rely upon several modes of communication to support their operations, including telephone, email, internal messaging, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises solutions, meaning that remote workers and those who are generally increasingly mobile may be unable to rely upon them. One solution is by way of a unified communications as a service (UCaaS) platform, which includes several software services corresponding to multiple communications modalities integrated over a network, such as the Internet, to deliver a complete communication experience regardless of physical location. The software services of a UCaaS platform may thus enable synchronous and asynchronous communications between users. In some cases, the software services of a UCaaS platform may implement other functionality as well, for example, for using digital whiteboards, making workspace reservations, or the like.

A software platform, such as a UCaaS platform, may provide artificial intelligence (AI) functionality for use with the software services thereof. Use of the AI functionality may enhance the user experience by automating processes, answering prompted questions with minimal or no disruption to an active communication session, or introducing capabilities previously unavailable to software service users. Such AI functionality may be implemented using one or more machine learning (ML) models, which may be trained to process specific types of input and produce specific types of output. For example, ML functionality enabled for use during a video conference may be implemented using a large language model (LLM) trained to obtain user requests as natural language prompts and to produce output responsive to the user requests in a same language as that which the prompts are obtained. In one non-limiting example, a video conference participant who joins the video conference after it began may submit a user request to an LLM to ask for a summary of the discussion that occurred during the video conference before the participant joined. The LLM may evaluate a real-time transcription of the video conference (e.g., produced using automated speech recognition or a like tool) to present output concisely summarizing that discussion.

ML models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In the realm of natural language processing, AI training software employs a learning paradigm focused on human preferences to better align pretrained and instruction-tuned generative language models with human values. This process involves the AI training software collecting extensive data, where each data point comprises a context, pairs of continuations of the context (generations), and a pairwise human preference indicating the superior generation. Subsequently, the AI training software learns to generate optimal continuations for a given context based on the collected data.

In some cases, the AI training software may employ reinforcement learning (RL), which is a method of training neural networks that may be used for training LLMs. Similar to human learning, RL trains neural networks through trial and error. Specifically, the neural network produces an output, receives feedback regarding this output, and then learns from the feedback. For instance, when finetuning a language model using reinforcement learning from human feedback (RLHF), the language model generates text and receives a score or reward from a human annotator, which reflects the quality of the text. The AI training software then employs RL to finetune the language model to generate outputs with high scores.

Reinforcement learning proves to be an advantageous and promising learning algorithm for neural networks because it allows learning from non-differentiable signals, which are incompatible with supervised learning. This capability enables the AI training software to learn from arbitrary feedback on a neural network's output. In the case of RLHF, the outputs generated by a language model can be scored according to any predefined principle. The AI training software then uses RL to learn from these scores, regardless of their definition.

Problems addressed via RL are typically structured in a consistent format. Specifically, an agent interacts with an environment, maintaining a state within this environment and producing actions that can alter the current state. As the agent interacts with the environment, it can receive both positive and negative rewards for its actions. The agent's objective is to maximize the rewards received, although not every action is associated with a reward. Rewards may have a long horizon, necessitating several correct, consecutive actions to generate any positive reward. In mathematical terms, RL may be described as a Markov decision process (MDP). An MDP includes states, actions, rewards, transitions, and a policy. States and actions have discrete values, while rewards are real numbers. In an MDP, a policy (referred to herein, interchangeably as a “policy model”) takes a state as input and outputs a probability distribution over possible actions. Given this output, a decision can be made for the action to be taken from a current state, and the transition is then a function that outputs the next state based upon the prior state and chosen action. Using these components, the agent can interact with the environment in an iterative fashion to generate a trained policy.

The techniques and methodologies for training AI models have advanced significantly, enabling the development of systems capable of performing complex cognitive tasks with increasing efficiency and accuracy. Despite these advancements, AI applications often remain generalized, limiting their adaptability to specific organizational needs. While such models excel in processing vast amounts of data and generating insights, they fall short in addressing the unique workflows and administrative burdens faced by knowledge workers in particular industries. Thus, there is a need for AI systems that not only leverage these advanced training techniques but also offer customization options for organizations to create tailored solutions that enhance productivity in specific operational contexts.

Knowledge workers often spend a significant portion of their time on administrative and routine tasks rather than focusing on high-value work that requires their expertise. Existing AI solutions, while helpful, lack the ability for users to create tailored versions specific to their organization's needs and workflows. There is a need for a system that allows organizations to build sophisticated AI competencies that can reason and perform tasks, such as scheduling, meeting note-taking, email communication, and research.

Current AI solutions offer limited customization options, making it challenging for enterprises to adapt them to their specific processes and requirements. This results in a gap between the potential of AI to enhance productivity and its practical implementation in diverse organizational contexts. Additionally, many existing AI tools operate as isolated solutions, lacking seamless integration with the wide array of applications and services used in modern workplaces.

Furthermore, there is a shortage of user-friendly platforms that empower non-technical knowledge workers to create and deploy custom AI solutions. This limitation restricts the widespread adoption and utilization of AI across various departments and roles within organizations, potentially hindering innovation and efficiency gains.

Implementations of this disclosure address problems such as these by providing an AI function management platform (e.g., incorporated within or otherwise accessible to a software platform such as a UCaaS platform) that enables users to create and deploy custom AI competencies, referred to as “AI Skills” or “AI Agents.” The platform includes a low-code studio environment where users can build their own organization-specific AI agents alongside pre-built AI agents. This allows users to easily create and deploy AI agents without requiring extensive coding expertise. The platform also features a drag-and-drop visual workflow builder for connecting routine processes across multiple integrations and applications, and a grounding feature that facilitates grounding AI agents. The grounding feature may allow users to incorporate company-specific data, vocabularies, and guidelines into their AI agents. Additionally, the platform includes tools for managing, deploying, monitoring, and collecting feedback on AI agents, enabling users to track performance and make adjustments as needed. By empowering users to tailor AI solutions to their specific needs, the AI function management platform enhances productivity and efficiency for knowledge workers across various industries and departments.

In some examples of this disclosure, implementations may include or otherwise use one or more AI or ML (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

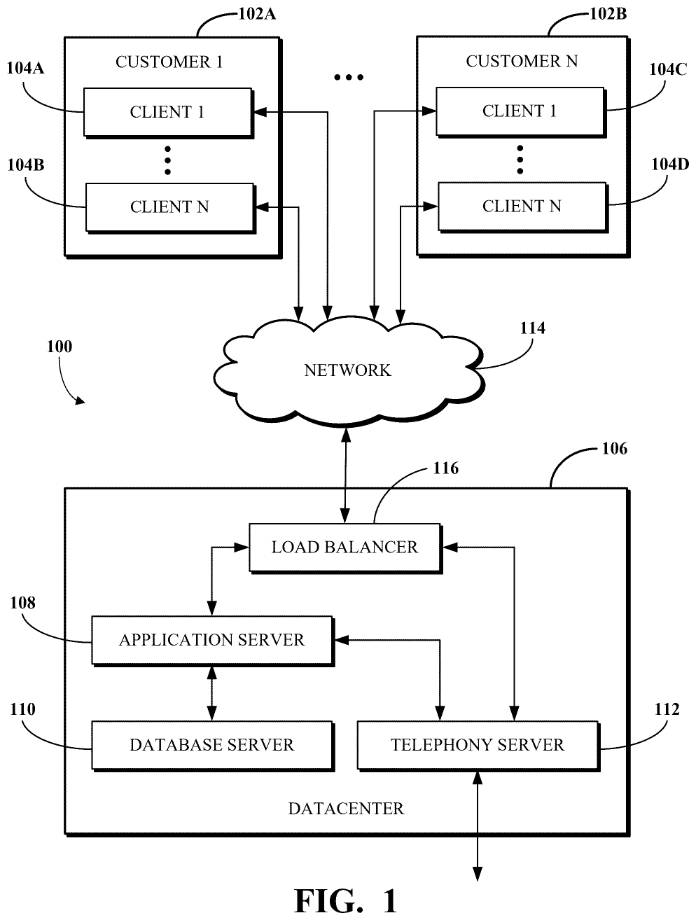

To describe some implementations in greater detail, reference is first made to examples of hardware and software structures used to implement a system for creation and management of AI functions. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

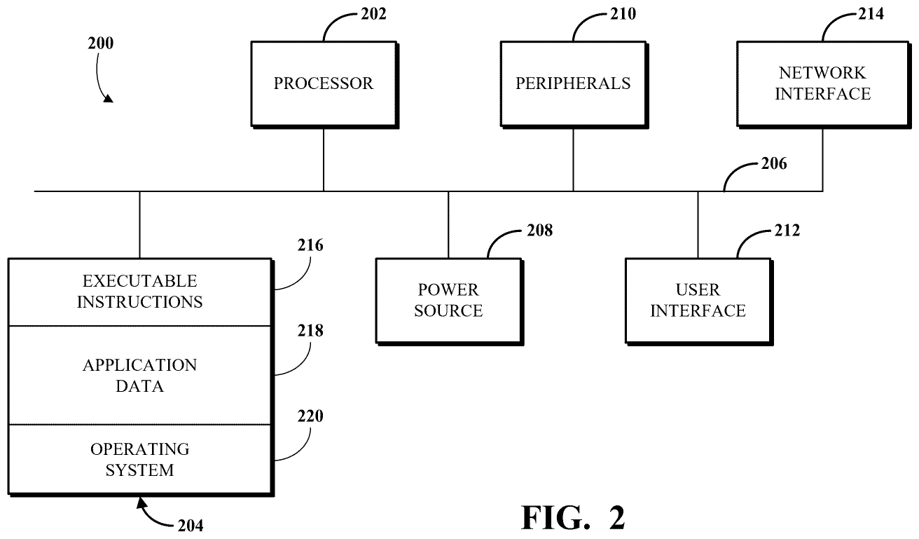

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

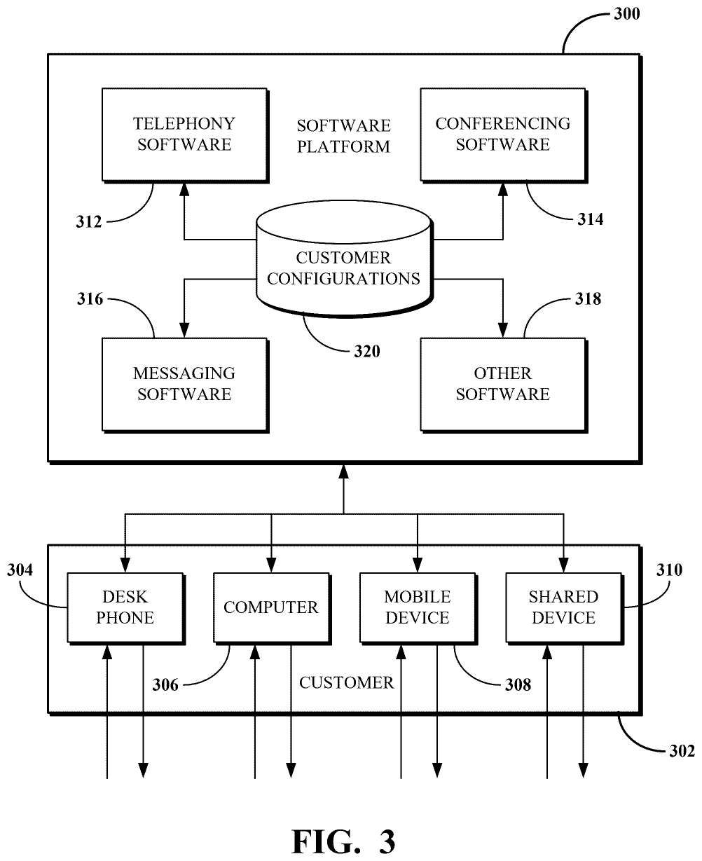

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include an AI function management platform and/or one or more aspects thereof, as described herein. In some such cases, the telephony software 312, the conferencing software, and/or the messaging software 316 may include or otherwise use the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

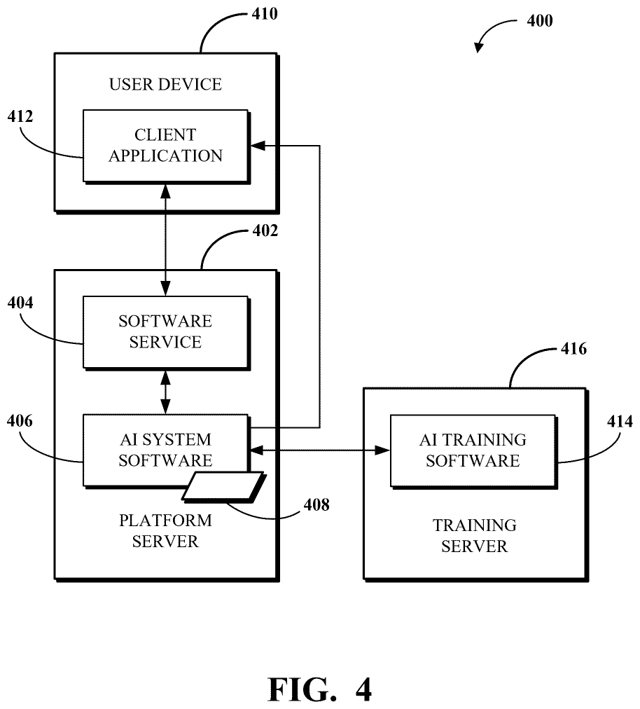

FIG. 4 is a block diagram of an example of an AI system 400 for processing user requests associated with software services of a software platform, such as the software platform 300 shown in FIG. 3. The AI system 400 includes a platform server device 402 that implements a software service 404, AI system software 406, and one or more ML models 408 such as one or more LLMs. For example, the platform server device 402 may include one or more application servers and/or database servers, such as the application server 108 and the database server 110 shown in FIG. 1, used to implement the software service 404, the AI system software 406, and the one or more ML models 408. In some cases, the platform server device 402 may be or otherwise include multiple servers. In such a case, the software service 404, the AI system software 406, and the one or more ML models 408 may be implemented across the multiple servers in one or more ways.

The software service 404 is, includes, or otherwise refers to the components used to run (e.g., execute or interpret) application-level software. For example, the software service 404 may facilitate synchronous or asynchronous communications, such as via one of the software services 312 through 316 shown in FIG. 3. In another example, the software service 404 may facilitate functionality directly related, indirectly related, or unrelated to synchronous or asynchronous communications, such as appointment scheduling, event hosting, knowledgebase compilation, digital whiteboarding, workspace reservation, and the like. The software service 404 may thus be one of many software services of the software platform, in which some or all of those other software services may also be implemented by the platform server device 402 or by one or more other server devices associated with the software platform.

The software service 404 is accessed by a user device 410, which is a personal or shared computing device configured to run a client application 412 associated with the software service 404. For example, the user device 410 may be one of the clients 304 through 310 shown in FIG. 3. The client application 412 may be a software application installed on the user device 410 and used to access the various software services of the software platform via one or more client-side graphical user interfaces (GUIs). Alternatively, the client application 412 may be a web-based application instantiated based on requests processed in connection with a web browser running at the user device 410. In some implementations, the client application 412 may be omitted, in which case the user device 410 may instead access the software service 404 using other web browser-based approaches or a different software application.

In one non-limiting example, the software service 404 may correspond to conferencing software (e.g., the conferencing software 314 shown in FIG. 3) for facilitating video conferences between users of user devices including the user device 410. The user of the user device 410 connects to the video conference via the client application 412, which interfaces with the software service 404 to cause the user device 410 to join the video conference and thus enable synchronous communications over video and/or audio with the users of the other user devices. For example, the client application 412 may encode a video stream captured at the user device 410 and transmit the encoded video stream for rendering at the other user devices, and it may similarly receive encoded video streams originating at those other user devices and decode same to render the video of the other user device users at the user device 410. The user of the user device 410 may similarly use the client application 412 to access related functionality of the video conference, for example, chat tools for interacting with one or more participants via text, AI tools for summarizing video conference content, and the like.

The software service 404 may receive user requests initiated at the user device 410. The user requests are related to functionality of the software service 404 and correspond to tasks to be actioned by or otherwise on behalf of the software service 404, to generate and transmit responses to the user requests. Non-limiting examples of user requests include requests to summarize video conference content, requests to schedule an appointment or reserve a workspace, requests to classify digital whiteboards by content or creator, and the like. A user request may be initiated at the user device 410 in one or more ways, including, for example, by the user device 410 obtaining input from a user thereof, such as in response to a prompt.

The AI system software 406 obtains such a user request from the software service 404 and causes the one or more ML models 408 to process the user request to produce output responsive to the user request. The AI system software 406 then transmits the output to the software service 404 for the software service 404 to present to the user device 410. In some implementations, the AI system software 406 may orchestrate the execution of the one or more ML models 408 as part of a model chain by causing the one or more ML models 408, in sequence, to perform an inference operation to produce output based on the user request. In some implementations, the AI system software 406 may implement one or more ML models 408 independently of one another.

In some implementations, the AI system software 406 may be integrated with the software service 404. For example, the AI system software 406 and the software service 404 may be integrated into a single software component running on a single server (e.g., on a single server device or as a single service implemented on one or more server devices). This integrated approach may streamline the processing of user requests by eliminating the need for separate communication channels between the AI system software 406 and the software service 404. In such cases, the integrated software component may directly access the ML models 408 to process user requests and generate responses, potentially reducing latency and improving overall system performance.

In some implementations, the AI system software 406 may be implemented as a standalone service that can be accessed by multiple software services, including the software service 404. This modular architecture may allow for greater flexibility and scalability, as the AI capabilities can be easily extended to support various applications and use cases across the platform. In this configuration, the AI system software 406 may expose APIs that enable different software services to leverage its functionality, potentially fostering innovation and the development of AI-enhanced features across the platform.

In some implementations, the ML models 408 may operate independently rather than as part of a model chain. For example, each model may be specialized for a specific task or domain and may be invoked directly by the AI system software 406 based on the nature of the user request. This approach may allow for more efficient use of computational resources, as only the relevant models are executed for each request. Additionally, this configuration may facilitate easier updates and maintenance of individual models without affecting the entire system. The AI system software 406 may include logic to determine which model or combination of models is most appropriate for processing each user request, potentially improving the accuracy and relevance of the generated responses.

In some implementations, the AI system software 406 may cause an execution of one or more ML models 408 at the user device 410. For example, the client application 412 may include or otherwise obtain (e.g., download from a source external to the user device 410) executable instructions for implementing an ML model at the user device 410. In some such implementations, the one or more ML models implemented at the user device 410 may be the first ML models of the model chain. Thus, server-side user request traffic may in such cases be avoided or at least limited based on the processing of user requests being handled at the client-side.

In some implementations, the user device 410 may execute a lightweight version of the ML models 408, optimized for mobile or low-power devices. This approach may allow for faster response times and reduced network dependency for certain AI tasks. For example, the user device 410 may run a compressed or quantized version of a language model for real-time text suggestions or speech recognition during a video conference, while more complex tasks may still be offloaded to the platform server device 402.

In other implementations, the user device 410 may utilize a hybrid approach, where some ML models 408 are executed locally while others are accessed remotely. This may involve splitting the model chain across the user device 410 and the platform server device 402. For instance, initial data preprocessing or feature extraction may occur on the user device 410, with the processed data then sent to the platform server device 402 for more computationally intensive operations. This approach may balance the benefits of local processing with the power of server-side resources.

In cases where the user device 410 may not have the capability to execute ML models 408 locally, it may access model outputs through API calls or websocket connections to the platform server device 402. In this scenario, the user device 410 may send requests to the AI system software 406, which then manages the execution of the appropriate ML models 408 and returns the output. To optimize performance, the system may implement caching mechanisms on the user device 410 to store frequently accessed model outputs, reducing the need for repeated server requests for similar queries.

The one or more ML models 408 may include a trained policy model. The trained policy model may be an LLM trained using AI training software 414 implemented on a training server 416. In some implementations, the training server 416 may be, be similar to, include, or be included in, the platform server 402. In some other implementations, the training server 416 may be distinct from the platform server 402. The training server 416 may refer to any number of server devices and/or server instances. The training server 416 may include one or more servers, such as the application server 108 and the database server 110 shown in FIG. 1. In some implementations, the training server 416 may implement preference optimization software for training the one or more ML models 408.

In some implementations, the training server 416 may refer to a federated training system. A federated training system may be implemented to train ML models across multiple devices or servers while preserving data privacy and security. In this approach, instead of centralizing all training data on a single server, the federated training system distributes the training process across various participating devices or servers. Each participant may train the model on its local data, and only model updates or gradients are shared with a central server. The central server then aggregates these updates to improve the global model. This method may allow organizations to leverage diverse datasets from multiple sources without directly sharing sensitive information. Federated training may be particularly useful in scenarios where data cannot be centralized due to privacy concerns, regulatory requirements, and/or practical limitations. The system may enable collaborative learning while maintaining data locality, potentially improving model performance and generalization across different data distributions.

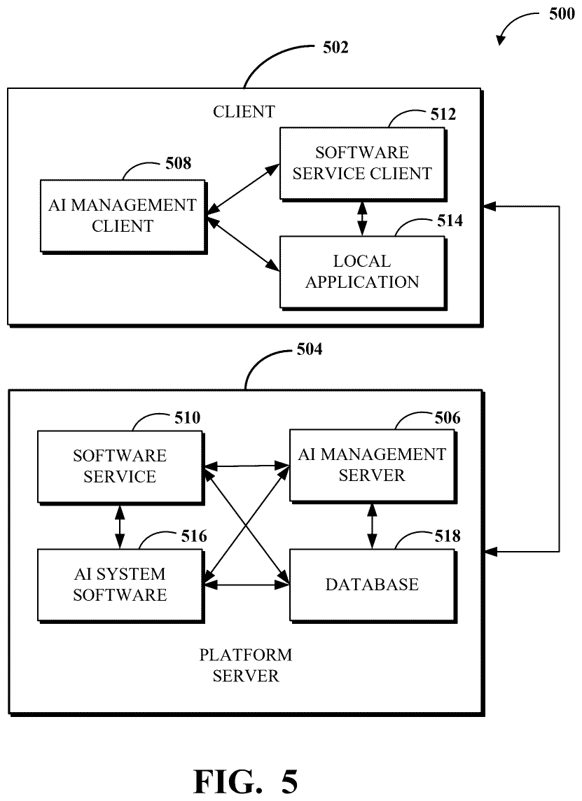

FIG. 5 is a block diagram illustrating a system 500 for managing artificial intelligence functions. The system 500 may be referred to as an AI function management platform. The system 500 includes a client device 502 and a platform server 504. The client device 502 may be, be similar to, include, or be included in, the user device 410 shown in FIG. 4, the customer 302 shown in FIG. 3, the computer 306 shown in FIG. 3, the mobile device 308 shown in FIG. 3, the shared device 310 shown in FIG. 3, the computing device 200 shown in FIG. 2, the customer 102A shown in FIG. 1, and/or the customer 102B shown in FIG. 1, among other examples. The platform server 504 may be, be similar to, include, or be included in, the platform server 402 shown in FIG. 4 (or one or more components thereof), the training server 416 shown in FIG. 4 (or one or more components thereof), the software platform 300 shown in FIG. 3 (or one or more components thereof), the computing device 200 shown in FIG. 2 (or one or more components thereof), and/or the datacenter 106 shown in FIG. 1 (or one or more components thereof), among other examples. The software service 510 may be, be similar to, include, or be included in, the software service 404 shown in FIG. 4. The software service client 512 and/or the local application 514 may be, be similar to, include, or be included in, the client application 412 shown in FIG. 4. The AI system software 516 may be, be similar to, include, or be included in, the AI system software 406 shown in FIG. 4.

The client device 502 may be a computing device such as a personal computer, mobile device, or shared device used by one or more users within an organization. In some implementations, the client device 502 may include multiple devices working in conjunction. The client device 502 hosts an AI management client 508, which provides a user interface for interacting with the AI function management system. The AI management client 508 may be a standalone application or integrated into existing software platforms used by the organization.

The AI management client 508 may interface with the AI management server 506 to provide user access to the AI agent creation and management tools. The AI management server 506 may be implemented as a combination of hardware and software components, and may include one or more processors, memory units, and specialized software modules. In some implementations, the AI management server 506 may be distributed across multiple servers or cloud-based resources to enhance scalability and performance. The AI management server 506 may also incorporate redundancy and fault-tolerance features to ensure high availability of the AI function management platform.

The AI management server 506 may provide a graphical user interface (GUI) configured to render a studio environment for creating AI agents. The AI management client 508 may render the GUI locally on the client device 502, allowing users to interact with the studio environment and visual workflow builder. This client-side rendering may improve responsiveness and provide a smoother user experience when designing AI agents. The studio environment may comprise a drag-and-drop visual workflow builder for connecting operations across multiple functional components of a set of available functional components. The AI management server 506 may include an AI agent generation component for translating user-defined workflows into executable code, and/or a performance monitoring component for tracking the effectiveness of deployed AI agents, among other examples.

The AI management server 506 may receive, via the studio environment, user input. The user input may be indicative of at least one AI component of the set of available functional components and/or at least one operation for performance by the at least one AI component. Based on the received user input, the AI management server 506 may generate the AI agent and deploy it to a runtime environment. This process allows users to create custom AI agents tailored to their specific needs without requiring extensive coding expertise. The AI management server 506 may also monitor the performance of deployed AI agents, collect feedback on their operation, and make adjustments as needed to improve their functionality.

As indicated above, the client device 502 also includes a software service client 512 and a local application 514. The AI management client 508 on the client device 502 may communicate with the software service client 512 and/or the local application 514. The software service client 512 may be a client-side component of a software service 510 provided by the platform server 504, such as a unified communications service or a productivity suite. The software service 510 may be a cloud-based service that provides various functionalities to users, such as communication tools, project management features, or data analysis capabilities. The software service client 512 may interact with the software service 510 implemented on the platform server 504. The local application 514 may be any software application (e.g., a word processing application, spreadsheet application, conferencing application, or email client) installed on the client device 502 that can benefit from AI functionality, such as via integration with AI agents created through the AI management system.

The platform server 504 includes AI system software 516, which may provide the underlying AI capabilities for the system 500. AI system software 516 may include various ML models (e.g., large language models, neural networks, and/or classifiers), natural language processing tools, and/or other AI algorithms that can be leveraged to create custom AI agents. The AI system software 516 may be designed to be modular and extensible, allowing for the integration of new AI technologies as they become available. The models associated with the AI system software 516 may be trained and fine-tuned based on organizational data and user feedback to improve their performance over time.

As shown, the database 518 is implemented on the platform server 504. The database 518 may store various types of data used by the AI management system, including user profiles, role information, organizational data, AI agent configurations, and/or performance metrics, among other examples. The database 518 may be implemented using various database technologies, such as relational databases, document stores, or graph databases, depending on the specific requirements of the system. The database 518 may be used to ground AI agents with organization-specific information, enhancing their contextual relevance and effectiveness within the organization's workflow.

The system 500 may address the problem of creating and managing sophisticated AI competencies within an organization. By providing a low-code studio environment with a visual workflow builder, the system enables users with varying levels of technical expertise to create custom AI agents. By providing a visual interface for creating AI agents, the system 500 allows users with domain expertise but limited coding skills to design and deploy sophisticated AI solutions. For example, a marketing professional could use the system 500 to create an AI agent that analyzes customer feedback across multiple channels and generates actionable insights, without needing to write complex algorithms or data processing scripts.

One advantage of implementing the system 500 is the ability to integrate AI agents seamlessly with existing workflows, software services, and local applications. The AI management client 508 can interact with both cloud-based services (via the software service client 512) and local applications (via the local application 514), allowing AI agents to be seamlessly incorporated into various aspects of an organization's operations. This integration capability may significantly enhance productivity by automating routine tasks and providing intelligent assistance across different software tools. For example, an AI agent created through the AI management server 506 could be integrated with the software service 510 to provide intelligent assistance during video conferences or to automate the summarization of meeting notes. Similarly, the AI agent could be integrated with the local application 514 to enhance its functionality with AI-powered features.

Another advantage of the system 500 is its scalability and flexibility. The platform server 504 can handle multiple client devices and users, allowing organizations to deploy AI agents across departments or teams. The system can also be easily extended to incorporate new AI technologies or integrate with additional software services as an organization's needs evolve.

In some implementations, the system 500 may include a grounding feature that facilitates grounding AI agents. Grounding an AI agent refers to the process of ensuring that the AI agent's understanding, predictions, and/or responses are tied to real-world knowledge, context, and/or specific data that is relevant and meaningful. In other words, grounding is about making sure that the agent's outputs are not purely abstract or disconnected from practical, verifiable information, but instead, are based on well-defined, factual, and/or contextually appropriate inputs. In some implementations, grounding may be incorporated into the training process. For example, during training, an AI model associated with an AI agent may be exposed to data that helps the AI model and/or the AI agent understand the real-world context, or specific mechanisms may be introduced to ensure the outputs from the AI model and/or the AI agent are grounded. Grounding can occur at different stages of model development, such as during training, inference, and/or fine-tuning, and may involve any number of different techniques depending on the type of agent, its use case, and/or the domain in which the AI agent operates.

In some implementations, grounding may be performed automatically by the system 500 and/or in response to user input. For example, the system 500 may allow users to incorporate company-specific data, vocabularies, and/or guidelines into AI agents. The grounding process may involve selecting organizational data sources through the studio environment and incorporating the selected data into the AI agent to enhance its contextual relevance. For instance, an AI agent designed for customer support could be grounded with the organization's product documentation and frequently asked questions, enabling it to provide more accurate and relevant responses.

The AI management server 506 may include a role profiling component that manages user roles and permissions within the system. This component ensures that access to AI agents and their functionalities is appropriately controlled, addressing potential security and privacy concerns. For example, a human resources AI agent might have access to sensitive employee data, and the role profiling component would ensure that only authorized personnel can create or modify such an agent.

The system 500 may also include role-based access controls for managing permissions associated with AI agents. These controls may define which users can create, edit, or execute specific AI agents based on their roles within the organization. For example, a manager may have permissions to create and deploy AI agents for their team, while individual team members may only have permissions to use the deployed agents.

The performance monitoring capabilities of the AI management server 506 provide valuable insights into the effectiveness of deployed AI agents. The AI management server 506 may collect data on factors such as response time, accuracy, user satisfaction, and/or resource utilization. The collected data may be used to generate reports and insights that help organizations optimize their AI agent deployments and identify areas for improvement. This feature may allow organizations to continuously improve their AI solutions based on real-world performance data. For instance, if an AI agent designed to automate customer support interactions is not performing as expected, the system 500 can provide detailed analytics to help identify areas for improvement or may automatically make improvements to the AI agent based on the performance data. The system 500 may also include a feedback component that collects and processes user feedback on AI agents. This feature enables continuous improvement and refinement of AI solutions based on user experiences. For instance, if users find that an AI agent for meeting summarization is missing key points, their feedback can be used to fine-tune the agent's performance.

In some implementations, the system 500 may include a federated learning component that allows AI agents to be trained across multiple client devices while maintaining data privacy. This approach may be particularly useful for organizations with strict data protection requirements or those operating in regulated industries or across multiple regions. For example, a multinational corporation could use the system to create AI agents that learn from data stored in different countries without needing to centralize that data. The federated learning component could enable the AI system software 516 to improve its models based on aggregated insights from multiple users without directly accessing individual user data.

In some implementations, the system 500 may include a marketplace feature that allows users to share and discover pre-built AI agents or components. This marketplace could foster collaboration and knowledge sharing within the organization, enabling users to leverage existing solutions and build upon them to create more sophisticated AI agents. The marketplace feature may include rating and review systems to help users identify high-quality agents and components.

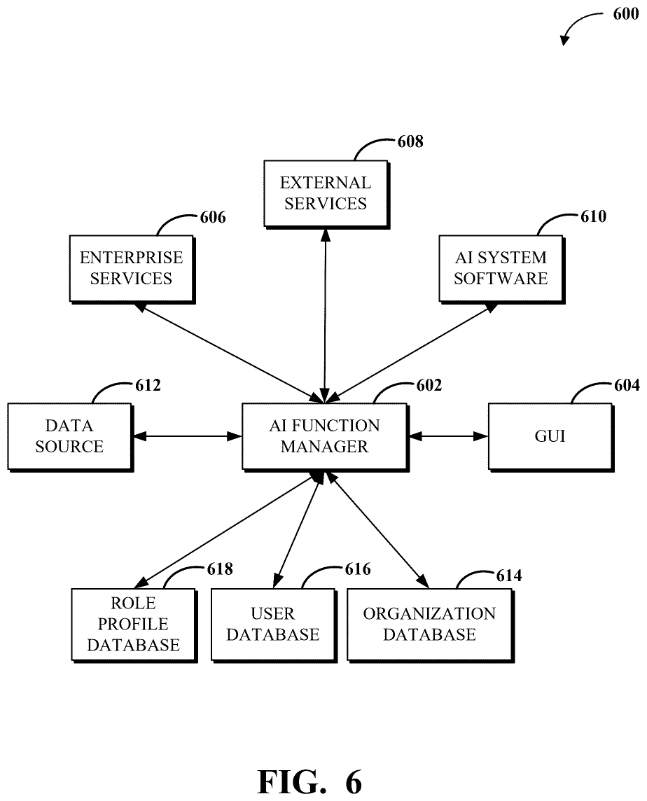

FIG. 6 illustrates a block diagram of a system 600 for managing AI functions. The system 600 or one or more components thereof may be referred to as an AI function management platform. Any one or more components of the system 600 may implemented using one or more components of the computing device 200 shown in FIG. 2. The system 600 addresses the problem of creating and managing sophisticated AI competencies within an organization by providing a comprehensive platform for developing, deploying, and managing custom AI agents. This solution enables organizations to leverage AI technology effectively without requiring extensive coding expertise from their employees.

The system 600 includes an AI function manager 602, a graphical user interface (GUI) 604, enterprise services 606, external services 608, AI system software 610, a data source 612, an organization database 614, a user database 616, and a profile database 618. The AI function manager 602 may be, be similar to, include, or be included in, the AI management server 506 shown in FIG. 5 and/or the AI management client 508 shown in FIG. 5. The GUI 604 may be provided by the AI function manager 602 and may be, be similar to, include, or be included in, the client 502 shown in FIG. 5 and/or the platform server 504 shown in FIG. 5. The enterprise services 606 may be, be similar to, include, or be included in, the software service 510 shown in FIG. 5, the software service client 512 shown in FIG. 5, and/or the local application 514 shown in FIG. 5. The external services 608 may include any services provided from outside the AI function management platform. The AI system software may be, be similar to, include, or be included in, the AI system software 516 shown in FIG. 5 and/or the AI system software 406 shown in FIG. 4. The data source 612, the organization database 614, the user database 616, and/or the profile database 618 may be, be similar to, include, or be included in, the database 518 shown in FIG. 5, the software platform 300 shown in FIG. 3, and/or the datacenter 106 shown in FIG. 1.

The AI function manager 602 may be implemented as a combination of hardware and software components, and may include one or more processors, memory units, and specialized software modules. In some implementations, the AI function manager 602 may be distributed across multiple servers or cloud-based resources to enhance scalability and performance. The AI function manager 602 may also incorporate redundancy and fault-tolerance features to ensure high availability of the AI function management platform.

The AI function manager 602 may receive a request to create an AI agent and may provide, based on the request, the GUI 604. The GUI 604 may be implemented as a web-based interface, a desktop application, or a mobile app, providing flexibility in how users access and interact with the system. The GUI 604 may include a studio environment for creating and managing AI agents, as described above in connection with FIG. 5. The studio environment may feature a drag-and-drop visual workflow builder that allows users to connect operations across multiple functional components of a set of functional components. The set of functional components may include any number of functional component associated with the enterprise services 606, the external services 608, and/or the AI system software. For example, the AI function manager 602 may interface with the enterprise services 606 and/or the external services 608, enabling seamless integration of AI agents with existing organizational systems and third-party applications.

The enterprise services 606 may include various internal software tools and platforms used within an organization. These enterprise services 606 may encompass communication tools, project management software, data analysis platforms, and/or other business-related applications, among other examples. The AI function manager 602 may integrate with these services to enhance their capabilities with AI functionalities or to utilize data from these services in AI agent operations. The enterprise services 606 may be, be similar to, include, or be included in, the software service 510, the software service client 512, the local application 514, and/or the AI system software 516 shown in FIG. 5; the software service 404, the AI system software 406, the AI training software 414, and/or the client application 412 shown in FIG. 4; and/or the telephony software 312, the conferencing software 314, the messaging software 316, and/or the other software 318 shown in FIG. 3; among other examples.

The external services 608 may include third-party or cloud-based services that can be leveraged by the AI function management platform. These external services 608 may include APIs, data providers, and/or specialized AI services that can be incorporated into custom AI agents, among other examples. The ability to integrate with both enterprise and external services allows for the creation of highly versatile and powerful AI agents that can operate across various platforms and data sources. This integration capability allows organizations to enhance their current workflows and processes with AI-powered functionalities, potentially leading to increased efficiency and productivity. For example, an AI agent created through the system 600 could be integrated with an enterprise email service to automatically categorize and prioritize incoming messages, or with an external customer relationship management (CRM) system to provide intelligent insights based on customer interactions.

The AI system software 610 provides the underlying AI and ML capabilities for the platform. The AI system software 610 may include various pre-trained models, algorithms, and/or tools that can be used to build custom AI agents, among other examples. The AI system software 610 may support different types of AI technologies, such as natural language processing, computer vision, predictive analytics, and more. It may also include features for model training, fine-tuning, and optimization to ensure that AI agents can be tailored to specific organizational needs. The AI system software 610 may be responsible for executing the AI agents created through the AI function manager 602. For example, the AI function manager 602 may generate an AI agent based on user input received via the studio environment and deploy it to a runtime environment within the AI system software 610.

The data source 612 provides access to various types of data used by the AI management system. This may include structured and unstructured data from various sources within and outside the organization. The data source 612 may be implemented using different storage technologies, such as relational databases, data lakes, and/or distributed file systems, depending on the volume and variety of data being managed. The AI function manager 602 may include data integration and preprocessing capabilities to ensure that data from the data source 612 is properly formatted and prepared for use by AI agents. In some implementations, the data source 612 may include the organization database 614, the user database 616, and/or the role profile database 618, among other examples. In some implementations, one or more of the organization database 614, the user database 616, and the role profile database 618 may be independent of the data source 612. In some implementations, any two or more of the data source 612, the organization database 614, the user database 616, and the role profile database 618 may be integrated with one another. Any of the data source 612, the organization database 614, the user database 616, and the role profile database 618 may represent any number of databases, data structures, and/or the like, and may be implemented on any number of devices such as on a single device, duplicated across multiple devices, and/or distributed across multiple devices.

The organization database 614 stores information specific to the organization using the AI function management platform. This may include organizational structure, policies, procedures, company-specific data, vocabularies, guidelines and/or other relevant data that can be used to enhance the contextual understanding of AI agents (e.g., to ground AI agents in the context of the organization). The organization database 614 may be regularly updated to reflect changes in the organization, ensuring that AI agents always operate with the most current organizational information. For instance, an AI agent designed for internal technical support could be grounded with the organization's information technology (IT) infrastructure documentation and common troubleshooting procedures, enabling it to provide more accurate and relevant assistance to employees.

The user database 616 contains information about individual users of the system (e.g., users within the organization and/or external users such as customers and/or vendors). The user database 616 may include information such as identifying information, user preferences, user demographic data, access credentials, information about users' interactions with other users, information about users' interactions with the enterprise services 606 and/or the external services 608, and/or information about users' interactions with the AI system software 610 and/or the AI function manager 602, among other examples. In some implementations, the user database 616 may be used by the AI function manager 602 and/or the AI system software 610 to facilitate personalizing AI agent interactions with users. Personalization may lead to more effective and efficient use of AI agents, as the AI agents can adapt their responses and recommendations based on a user's experiences, preferences, and/or past interactions, among other examples.

The role profile database 618 contains information about different roles within the organization and their associated permissions and access levels. The role profile database 618 database supports the implementation of role-based access controls for managing permissions associated with AI agents. The role-based access controls may define which users can create, edit, and/or execute specific AI agents based on the users' roles within the organization. For example, a department head may have permissions to create and deploy AI agents for their entire department, while team leaders may only have permissions to customize existing agents for their specific teams.

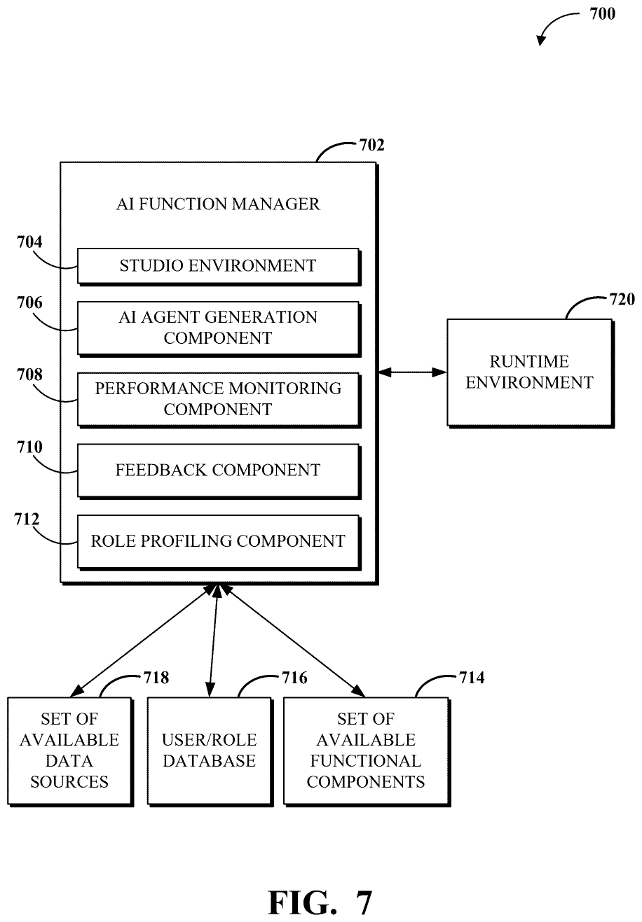

FIG. 7 illustrates an example 700 of an AI function management system that expands upon the concepts introduced in FIGS. 5 and 6. The system includes an AI function manager 702, which may be configured for creating, managing, and deploying AI agents within an organization. The AI function manager 702 may be implemented as a combination of hardware and software components, and may be distributed across multiple servers or cloud-based resources to enhance scalability and performance. The AI function manager 702 may be, be similar to, include, or be included in, the AI function manager 602 shown in FIG. 6.

The AI function manager 702 includes a number of components, each designed to address specific aspects of AI agent management. The studio environment 704, which may be provided via a GUI, facilitates creating and managing AI agents. This environment may include a drag-and-drop visual workflow builder, as described above in connection with FIGS. 5 and 6, allowing users to connect operations across multiple functional components. The studio environment 704 may also incorporate features for role-based access control, ensuring that users can only create or modify AI agents within their designated permissions. The studio environment 704 may offer a set of pre-built components and templates that users can customize to suit their specific needs. In some implementations, the studio environment 704 may also support scripting or advanced coding options for users who desire more fine-grained control over their AI agents.

The AI agent generation component 706 may be configured to translate user-defined workflows and configurations into executable AI agents. The AI agent generation component 706 may leverage various ML models and algorithms provided by the AI system software, as described above in connection with FIGS. 5 and 6. The AI agent generation component 706 may support different types of AI technologies, such as natural language processing, computer vision, and predictive analytics. In some implementations, the AI agent generation component 706 may also include features for model training and fine-tuning, allowing organizations to tailor AI agents to their specific needs. In some implementations, the AI agent generation component 706 may employ techniques such as automated code generation or neural architecture search to optimize the structure and performance of the generated AI agents. Additionally, this component may incorporate version control features, allowing users to track changes and revert to previous versions of their AI agents if needed.

The performance monitoring component 708 tracks the effectiveness of deployed AI agents. The performance monitoring component 708 may collect data on factors such as response time, accuracy, user satisfaction, and/or resource utilization. The performance monitoring component 708 may generate reports and insights that help organizations optimize their AI agent deployments and identify areas for improvement. In some implementations, the performance monitoring component 708 may incorporate ML algorithms to automatically detect performance anomalies and suggest optimizations. In some implementations, the performance monitoring component 708 may use advanced analytics techniques, including anomaly detection and predictive modeling, to identify potential issues before they impact the AI agents' performance. The performance monitoring component 708 may also provide customizable dashboards and alerts, allowing organizations to monitor their AI agents' performance in real-time and receive notifications when predefined thresholds are exceeded.

The feedback component 710 collects and processes user feedback on AI agents. The feedback component 710 enables continual improvement and/or refinement of AI solutions based on user experiences. The feedback component 710 may include mechanisms for collecting explicit feedback (e.g., user ratings or comments) and/or implicit feedback (e.g., user interaction patterns). In some implementations, the feedback component 710 may use natural language processing techniques to analyze textual feedback and extract actionable insights. In some implementations, the feedback component 710 may also incorporate A/B testing capabilities, allowing organizations to compare different versions of AI agents and make data-driven decisions about which features or configurations to implement. The feedback collected by the feedback component 710 may be used to automatically adjust AI agent parameters or to provide suggestions for manual improvements.

The role profiling component 712 manages user roles and permissions within the system. The role profiling component 712 component ensures that access to AI agents and their functionalities is appropriately controlled, addressing potential security and privacy concerns. The role profiling component 712 may interface with the organization's existing identity and access management systems to maintain consistency across the enterprise. In some implementations, the role profiling component 712 may support dynamic role assignment based on user behavior or organizational changes. In some implementations, the role profiling component 712 may employ ML techniques to analyze user behavior and suggest role adjustments or permission changes based on usage patterns and organizational needs.

The AI function manager 702 interacts with several elements to provide a comprehensive AI management solution. The set of available functional components 714 represents a library of AI components that can be used to build AI agents. These components may include pre-built modules for common AI tasks such as natural language processing, image recognition, or predictive analytics. In some implementations, the set of available functional components 714 may include customizable templates that organizations can adapt to their specific needs. In some implementations, the set of available functional components 714 may be extensible, allowing organizations to add their own custom components or integrate third-party AI services. In some implementations, as described above, the set of available functional components 714 may include enterprise services, external services, and/or AI services, among other examples.

The user/role database 716 stores information about users and their roles within the organization. The user/role database 716 may be, be similar to, include, or be included in the data source 612, the organization database 614, the user database 616, and/or the role profile database 618 shown in FIG. 6. This database may contain user profiles, access credentials, and role assignments. The user/role database 716 may be regularly updated to reflect changes in the organization's structure or personnel. In some implementations, this database may incorporate ML algorithms to suggest role changes or identify potential security risks based on user behavior patterns.

The set of available data sources 718 contains various data repositories that can be used to train and inform AI agents. These data sources may include internal organizational data (e.g., customer records, financial data, operational metrics) and/or external data (e.g., market trends, social media feeds, public datasets). The AI function manager 702 may include data integration and preprocessing capabilities to ensure that data from these sources is properly formatted and prepared for use by AI agents. In some implementations, the set of available data sources 718 may include internal databases, external APIs, and/or real-time data streams, among other examples. In some implementations, the system 700 may provide data integration tools to facilitate the connection and preprocessing of data from diverse sources, ensuring that AI agents have access to high-quality, relevant information. In some implementations, the set of available data sources may be, be similar to, include, or be included in the data source 612, the organization database 614, the user database 616, and/or the role profile database 618 shown in FIG. 6.

The runtime environment 720 is an environment in which the generated AI agents are deployed and executed. The runtime environment 720 may be, be similar to, include, or be included in the AI system software 610 shown in FIG. 6. The runtime environment 720 may be implemented on cloud platforms, on-premises servers, and/or edge devices, depending on the organization's requirements. The runtime environment 720 may include features for load balancing, auto-scaling, and/or fault tolerance to ensure optimal performance and reliability of deployed AI agents. In some implementations, the runtime environment 720 may support containerization technologies to facilitate easy deployment and management of AI agents across different infrastructure environments. The runtime environment 720 may be designed to scale dynamically based on demand, ensuring optimal performance and resource utilization.

In some implementations, the system 700 may include a marketplace feature that allows users to share and discover pre-built AI agents or components. This marketplace could foster collaboration and knowledge sharing within the organization, enabling users to leverage existing solutions and build upon them to create more sophisticated AI agents. The marketplace feature may include rating and review systems to help users identify high-quality agents and components.

To further enhance the system's capabilities, the AI function manager 702 may include an explainable AI (XAI) component. This component may provide transparency into the decision-making processes of AI agents, helping users understand how and why certain outputs or recommendations are generated. The XAI component may use techniques such as feature importance analysis, decision tree visualization, and/or natural language explanations to make AI agent behavior more interpretable and trustworthy.

The AI function management system 700 illustrated in FIG. 7 addresses the need for creating and managing sophisticated AI competencies within an organization. By providing a comprehensive platform for developing, deploying, and managing custom AI agents, this system 700 enables organizations to leverage AI technology effectively without requiring extensive coding expertise from their employees. The modular architecture of the AI function manager 702 allows for flexibility and scalability, enabling organizations to adapt the system to their evolving AI needs.

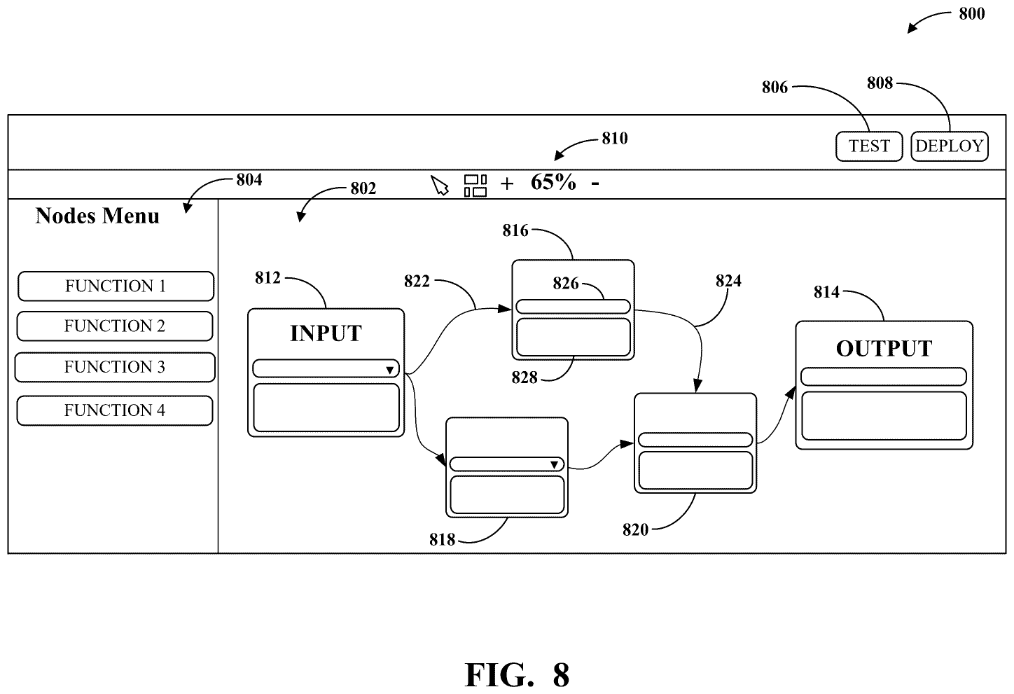

FIG. 8 illustrates a studio environment 800 for creating and managing AI agents. The studio environment 800 may be, be similar to, include, or be included in, the studio environment 704 shown in FIG. 7. The studio environment 800 provides a visual interface for users to design, configure, and deploy custom AI agents without requiring extensive coding knowledge.

The studio environment 800 includes a workflow builder 802. The workflow builder 802 includes a drag-and-drop interface for constructing AI agent workflows. This visual approach allows users to create complex AI functionalities by connecting various components and defining their interactions. In some implementations, the workflow builder 802 may support real-time collaboration, enabling multiple users to work on the same AI agent simultaneously. The workflow builder 802 may also include version control features, allowing users to track changes, compare different versions, and revert to previous states if needed.

The studio environment 800 includes a nodes menu 804 that provides a selection of functional components that can be added to the workflow. These components may correspond to the set of available functional components 714 shown in FIG. 7. The nodes menu 804 may be organized into categories, such as input/output nodes, processing nodes, and integration nodes. In some implementations, the nodes menu 804 may be customizable, allowing organizations to add their own custom nodes or integrate third-party components. The nodes menu 804 may also include a search function to help users quickly find specific components.

The toolbar 810 at the top of the studio environment 800 contains various controls for managing the AI agent creation process. For example, the toolbar 810 may include a test button 806 and a deploy button 808. The test button 806 may initiate a testing process, allowing users to validate the functionality of a created AI agent before deployment. The deploy button 808 may trigger a deployment process to move the AI agent from the development environment to a runtime environment (e.g., the runtime environment 720 shown in FIG. 7).

Within the workflow builder 802, users can connect different nodes to create the logic and structure of AI agents. In the illustrated example, an input node 812 and an output node 814 may represent the starting and ending points, respectively, of a workflow associated with an AI agent. In some implementations, a workflow may always include an input node 812 and an output node 814. In some implementations, the input node 812 and the output node 814 may be optional and/or may be replaced with specific functional nodes. The input node 812 may define the data sources and/or triggers that initiate operation of an AI agent. In some implementations, the input node 812 may support multiple input types, such as structured data, unstructured text, images, and/or real-time streams. The output node 814 may specify formatting and delivery options associated with output generated by the AI agent. For example, the output node 814 may include options for generating reports, sending notifications, and/or integrating with other systems.

In some implementations, the input node 812 and/or the output node 814 may be default nodes that may be used by the workflow builder 802 to abstract the input and output aspects of a workflow. An AI function manager 702 (e.g., which may provide the workflow builder 802) may automatically (e.g., by using AI to analyze the workflow) replace the input node 812 and/or the output node 814 (or any other node placed within the workflow builder 802) with a function when generating the AI. In this way, a user may be able to create an AI agent without knowing which specific functional components are most appropriate to accomplish tasks in the workflow. In some implementations, the AI function manager 702 may provide, via the studio environment 800, intelligent suggestions for node connections and parameter settings based on the context of the workflow and best practices in AI development.

Between the input and output nodes, a set of function nodes 816, 818, and 820 represent different operations or components of the AI agent. These function nodes may correspond to various AI technologies, such as natural language processing, ML models, and/or data analysis tools. In some implementations, the function nodes 816, 818, and 820 may be nested, allowing for the creation of complex, hierarchical workflows. The function nodes 816, 818, and 820 may also include error handling and logging capabilities to ensure robust operation of the AI agent. The function nodes 816, 818, and 820 are connected by process flows 822 and 824, indicating the sequence of operations within the AI agent. These process flows 822 and 824 may support conditional branching, allowing the AI agent to make decisions based on intermediate output. In some implementations, the process flows 822 and 824 may also support parallel processing, enabling multiple operations to be executed simultaneously for improved performance.

Each function node contains input fields (e.g., 826, 828) for configuring parameters or entering data relevant to that function. These input fields may support various data types and may include validation rules to ensure that users enter appropriate values. In some implementations, the input fields may be dynamically populated based on the context of the workflow or the organization's data sources. The input fields may also support variables and expressions, allowing for dynamic configuration of the AI agent based on runtime conditions. In some implementations, the input fields may include text input fields, drop-down menus, and/or radio buttons, among other examples.

In some implementations, the studio environment 800 may integrate with a role profiling component (e.g., the role profiling component 712 shown in FIG. 7) to implement role-based access controls. This integration may ensure that users can only access and modify components and data sources appropriate for their role within the organization. The studio environment 800 may also provide different views or modes based on the user's expertise level, offering simplified interfaces for beginners and more advanced options for experienced users.

In some implementations, the studio environment 800 may include a debugging mode that allows users to step through the AI agent's workflow, examining the state and output of each node during execution. This feature may help users identify and resolve issues in their AI agent designs more efficiently. The debugging mode may also provide performance metrics and resource utilization information to help optimize the AI agent's operation. The studio environment 800 may incorporate features from a performance monitoring component (e.g., the performance monitoring component 708 shown in FIG. 7) and/or a feedback component (e.g., the feedback component 710 shown in FIG. 7). Such integrations may allow users to view performance metrics and/or user feedback directly within the workflow builder 802, facilitating continual improvement of AI agents. The studio environment 800 may provide suggestions for optimizing the workflow based on this data, such as recommending more efficient components or identifying bottlenecks in the process flow.

The studio environment 800 may include workflow templates that provide pre-configured settings and structures for common AI agent scenarios. These templates may include node templates, which define specific functions or operations, and/or workflow templates, which encompass entire AI agent structures including multiple nodes, data flows, and/or triggers. A template may include predefined configurations for input/output modules, AI models, integration points with enterprise services or external APIs, and/or default parameter settings. In some implementations, templates may also specify resource allocation, security settings, and/or monitoring parameters, ensuring that AI agents are created and deployed in a consistent and optimized manner across different environments.

The studio environment 800 may offer a set of default templates covering common use cases such as customer service chatbots, data analysis agents, or meeting summarization tools. These default templates may be designed to align with industry best practices and may be regularly updated to incorporate new features or optimizations. Users may have the ability to customize these default templates to better suit their specific organizational needs, while still benefiting from the pre-configured baseline settings. In some cases, the system may use ML techniques to suggest the most appropriate template based on the user's requirements or past usage patterns.

In some implementations, the studio environment 800 may allow users to create and submit their own templates for personal or public use. User-created templates may be saved within the organization's private template library for reuse across different projects or departments. Additionally, the system may feature a marketplace or community platform where users can share their custom templates with the broader user base. This collaborative approach may foster innovation and knowledge sharing, enabling organizations to leverage diverse expertise and accelerate their AI development processes. The system may include rating and review mechanisms for shared templates, helping users identify high-quality and reliable options for their AI agent development needs.

The studio environment 800 shown in FIG. 8 represents one possible implementation of a user interface for creating and managing AI agents. However, various implementations may include different aspects, arrangements of components, or features. For example, the layout of the workflow builder 802 may be customized to suit different organizational needs or user preferences. In some implementations, the nodes menu 804 may be positioned on the right side of the interface or may be a floating panel that users can move around the screen. The number and types of function nodes available may vary depending on the specific AI technologies supported by the system. Some implementations may include additional tools or panels for data visualization, performance monitoring, or collaboration features. The toolbar 810 may contain different buttons or controls, and the process flows between nodes may be represented in various ways, such as using different line styles or colors to indicate different types of connections. Additionally, the input and output nodes may have different configurations or may be integrated into the function nodes themselves in some implementations.

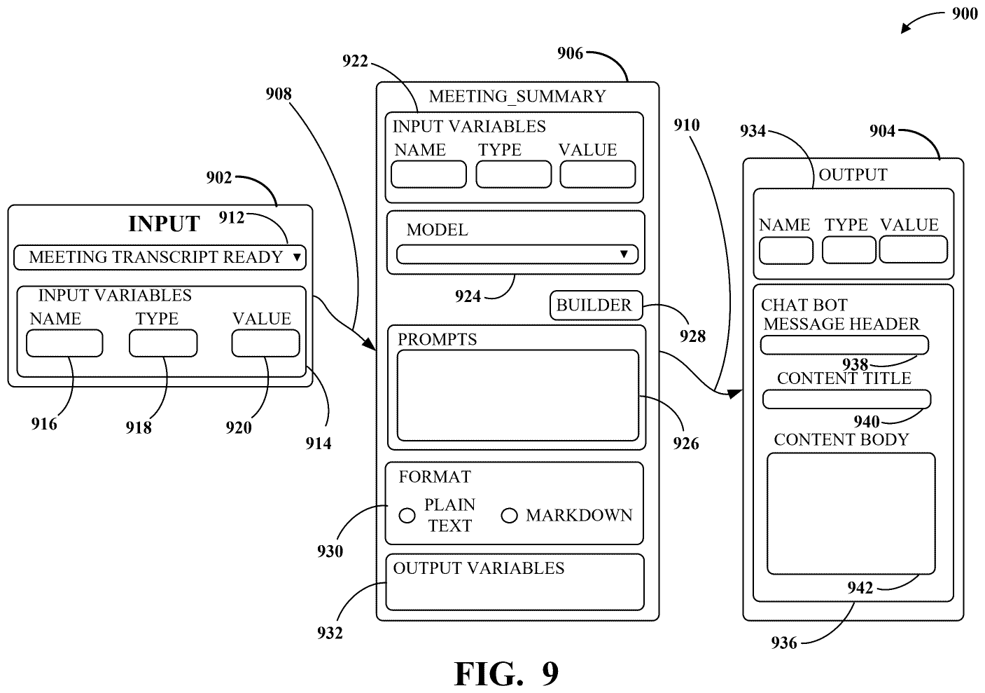

FIG. 9 illustrates an example of a workflow builder 900 specifically designed for creating an AI agent for meeting summarization. This example demonstrates how the system can be adapted to address specific organizational needs, such as improving the efficiency of meetings and knowledge sharing. The workflow builder 900 includes a number of functional components. The functional components include an input component 902, a meeting summary component 906, and an output component 904, connected by process flows 908 and 910.

The input component 902 includes a trigger input field 912 and an input variables component 914, allowing users to specify the conditions under which the AI agent should be activated and the input data it should process. In some implementations, the system may support various trigger types, such as scheduled events, user actions, or data changes, providing flexibility in how AI agents are initiated. Although illustrated as a drop-down menu, the trigger input field 912 may be implemented as a text input field and/or a radio button, among other examples. The input variables component 914 includes an input variables name field 916, an input variables type field 918, and an input variables value field 920. These fields may enable users to define and configure the input data that the AI agent will process. In some implementations, the input variables component 914 may support multiple input types, such as structured data, unstructured text, audio transcripts, and/or video streams, among other examples, allowing for versatile AI agent configurations. In some implementations, the input component 902 may include any number of different components, input fields, and/or arrangements thereof.

The meeting summary component 906 contains several components for configuring summarization capabilities of the AI agent. An input variables component 922 may allow users to specify additional input parameters specific to the summarization task. The model field 924 may enable users to select the underlying AI model for the summarization process. In some implementations, users may choose from a variety of pre-trained models optimized for different types of meeting summarization tasks, such as action item extraction, key point identification, or sentiment analysis. The prompts field 926 may allow users to customize the AI agent's behavior by providing specific instructions or guidelines for the summarization process. In some cases, the prompts field 926 may support natural language inputs, enabling users to fine-tune the AI agent's output without requiring technical expertise.

A builder button 928 is provided within the meeting summary module 906 to initiate the process of generating the AI agent based on the specified configuration. When activated, the builder button 928 may trigger the AI agent generation component (e.g., the AI agent generation component 706 shown in FIG. 7) to translate the user-defined workflow and configurations into an executable AI agent. The meeting summary module 906 also includes a format option component 930, which may allow users to specify the desired format for the meeting summary output. This component may offer various formatting options, such as bullet points, paragraphs, or structured data formats, to suit different organizational needs and preferences.

The meeting summary module 906 further includes an output variables component 932. The output variables component 932 may enable users to define and configure the output data that the AI agent will generate. In some implementations, users may specify multiple output variables to capture different aspects of the meeting summary, such as action items, decisions made, and/or participant contributions. The output variables component 932 may support various data types and structures, allowing for flexible integration with other systems or processes within the organization.

The output component 904 also may include an output variables component 934. The output variables component 934 may enable users to specify an output name, an output type, and/or an output value, among other examples. The output variables component 934 may enable users to define and configure the output data that the AI agent will generate. In some implementations, users may specify multiple output variables to capture different aspects of the meeting summary, such as action items, decisions made, and/or participant contributions. The output variables component 934 may support various data types and structures, allowing for flexible integration with other systems or processes within the organization.

The output component 904 contains a chat bot component 936 with fields for configuring how the summary will be presented to users. The chat bot component 936 includes a message header input field 938, a content title input field 940, and a content body input field 942. These fields may allow users to customize the presentation of the meeting summary within a chat interface or other communication channels. In some cases, the chat bot component 936 may support dynamic content generation, enabling the AI agent to adapt its output based on user preferences or contextual information.

The workflow builder 900 shown in FIG. 9 represents just one example of how an AI agent creation interface may be implemented for a specific use case. In practice, the system may support a wide variety of layouts, functionalities, and configurations to accommodate different organizational needs and AI agent types. For instance, the workflow builder may be adapted for creating AI agents focused on customer service automation, data analysis, or predictive maintenance. In some implementations, the layout may be modified to include a vertical flow instead of horizontal, or it may utilize a canvas-style interface where users can freely position and connect nodes. In some implementations, the system may offer a library of pre-built templates for common AI agent types, which users can customize and extend. The input and output modules may vary depending on the purpose of the AI agent, potentially including components for integrating with external data sources, APIs, and/or IoT devices. Additionally, the central module (e.g., the meeting summary module in FIG. 9) may be replaced with multiple interconnected modules for more complex AI agents, allowing for branching logic, parallel processing, or iterative operations. The system may also provide advanced features such as A/B testing capabilities, allowing users to compare different AI agent configurations, or integration with version control systems for collaborative development.

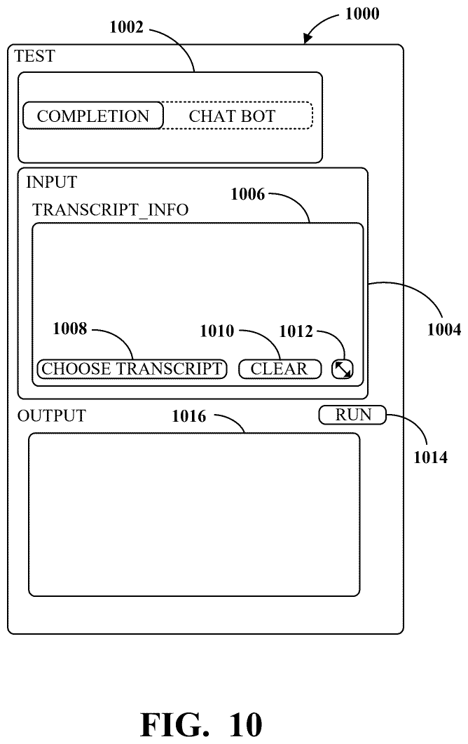

FIG. 10 illustrates a testing interface 1000 for an AI function management platform, providing an environment for validating and/or refining AI agents before deployment. The testing interface 1000 may be part of a GUI configured to render a studio environment for creating AI agents, as described herein. The testing interface 1000 may allow users to test AI agents created using the drag-and-drop visual workflow builder, ensuring that the agents perform as expected before deployment for use with a runtime environment.

The testing interface 1000 includes a test type component 1002. The test type component 1002 may allow users to choose between different testing modes, such as “COMPLETION” and “CHAT BOT,” enabling comprehensive testing of various AI agent functionalities.

The testing interface 1000 includes an input component 1004 that provides a transcript information display 1006 and buttons for managing test inputs, including a choose transcript button 1008, a clear button 1010, and an expand button 1012. These features allow users to easily input and manipulate test data, ensuring that AI agents are evaluated under various scenarios. In some implementations, the system may provide a library of pre-defined test cases or the ability to generate synthetic test data, further enhancing the testing capabilities. The choose transcript button 1008 may enable users to select from a library of pre-defined test cases or upload custom test data. This feature may be particularly useful for organizations that want to ensure their AI agents can handle a wide range of scenarios or comply with specific testing protocols. The clear button 1010 may allow users to quickly remove the current input data and start fresh, which can be helpful when iterating through multiple test cases. The expand button 1012 may provide a way to view the full transcript or input data in a larger format, facilitating detailed analysis of complex inputs.

The output component 1016 displays the results of the test, allowing users to assess the AI agent's performance and make necessary adjustments. The output component 1016 may show the results generated by the AI agent in response to the input data. The output component 1016 may be designed to present the AI agent's responses in a format that closely mimics how they would appear in the actual deployment environment. This approach may help users assess not only the accuracy of the AI agent's responses but also their presentation and usability. A run button 1014 is also provided. When clicked, the run button 1014 may initiate the testing process, causing the AI agent to process the input data and generate output that is then displayed in the output component 1016. The run button 1014 may be connected to the AI agent generation component, triggering the execution of the AI agent based on the user-defined workflow and configurations.

The testing interface 1000 shown in FIG. 10 represents one possible implementation of a user interface for testing AI agents. However, various implementations may include different components, arrangements, or features. For example, the layout of the testing interface 1000 may be customized to suit different organizational needs or user preferences. In some implementations, the test type component 1002 may offer additional testing modes beyond “COMPLETION” and “CHAT BOT” to accommodate a wider range of AI agent functionalities. The input component 1004 may include different options for data input, such as file upload capabilities and/or integration with external data sources. The output component 1016 may be expanded to include more detailed analytics, visualizations, and/or comparison tools. Additionally, the testing interface 1000 may incorporate features for automated testing, allowing users to define and run test suites or perform stress testing on their AI agents. The system may also support collaborative testing workflows, enabling multiple users to review and provide feedback on AI agent performance within the testing interface.

In some implementations, the testing interface 1000 may support batch testing capabilities. This feature may allow users to run multiple test cases simultaneously, providing a more comprehensive view of the AI agent's performance across various scenarios. The results of batch tests may be presented in a summary format within the output component 1016, with options to drill down into individual test case results. The testing interface 1000 may also incorporate real-time performance metrics. As the AI agent processes the test input, the interface may display metrics such as response time, accuracy scores, or resource utilization. These metrics may help users identify potential performance bottlenecks or areas for optimization in their AI agent designs. In some implementations, the testing interface 1000 may include additional features to enhance the testing process. For example, a debugging mode may be added, allowing users to step through the AI agent's decision-making process and examine intermediate outputs. This feature may be particularly useful for complex AI agents with multiple interconnected components or decision points.

The testing interface 1000 may also support A/B testing capabilities. Users may be able to create multiple versions of an AI agent and run them side by side using the same input data. The output component 1016 may then display the results from each version, allowing users to compare performance and make data-driven decisions about which configuration to deploy. Integration with the performance monitoring component and feedback component of the AI function management system may further enhance the testing interface 1000. Historical performance data and user feedback collected from deployed AI agents may be incorporated into the testing process, allowing users to validate improvements or assess the impact of changes on known issues or edge cases. The testing interface 1000 may also include features for automated testing and continuous integration. Users may be able to define test suites that can be run automatically whenever changes are made to the AI agent's configuration. This capability may help ensure that updates or modifications to AI agents do not inadvertently introduce errors or degrade performance.

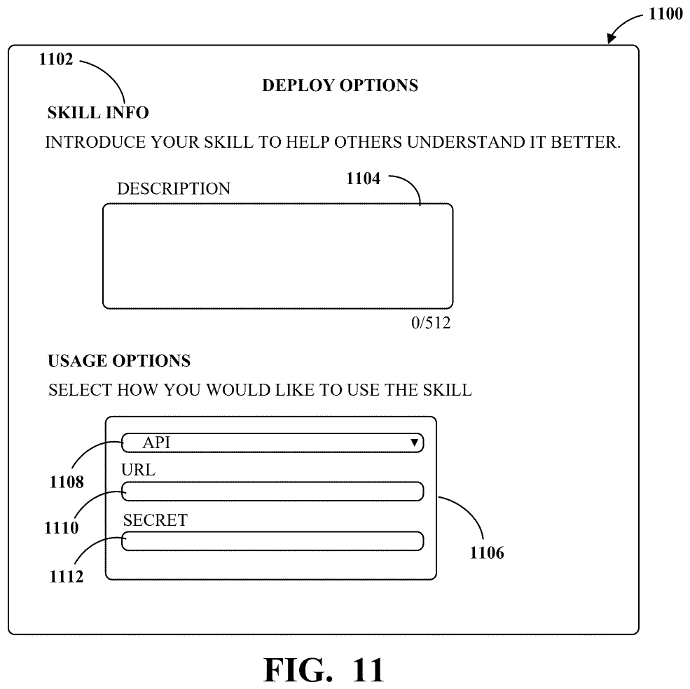

FIG. 11 illustrates a deployment interface 1100 for the AI function management platform, addressing the need for seamless integration of AI agents into existing organizational workflows. The interface includes a description input field 1104 where users can enter details about the AI skill being deployed, ensuring proper documentation and facilitating future management of the agent.

The usage options component 1106 with a drop-down menu 1108 allows users to specify how the AI skill will be used, providing flexibility in deployment scenarios. The URL input field 1110 and secret input field 1112 enable secure deployment and access to the AI agent. In some implementations, the system may support various deployment options, such as cloud-based, on-premises, or edge deployment, catering to different organizational requirements and constraints.

The deployment interface 1100 shown in FIG. 11 represents one possible implementation of a user interface for deploying AI agents. However, various implementations may include different features, arrangements, and/or components to suit diverse organizational needs and deployment scenarios. In some implementations, the deployment interface 1100 may include additional security options, such as multi-factor authentication and/or role-based access controls. The layout may be modified to accommodate a wizard-style deployment process, guiding users through multiple steps with progress indicators. Some versions may incorporate a visual representation of the deployment environment, allowing users to drag and drop AI agents into specific locations or services. The interface 1100 may also include options for scheduling deployments, setting up automatic updates, and/or configuring load balancing across multiple instances. In certain implementations, the deployment interface 1100 may provide integration with version control systems, allowing users to select specific versions of AI agents for deployment.

Additionally, the system may offer deployment templates for common scenarios, such as chatbots for customer service or data analysis agents for business intelligence, which users can customize to their specific needs. Deployment templates may provide pre-configured settings and workflows for common AI agent deployment scenarios, streamlining the process of integrating AI agents into existing organizational systems. These templates may include predefined configurations for input/output modules, AI models, and integration points with enterprise services or external APIs. In some cases, deployment templates may also specify resource allocation, security settings, and monitoring parameters, ensuring that AI agents are deployed in a consistent and optimized manner across different environments.

The AI function management platform may offer a set of default deployment templates covering common use cases such as customer service chatbots, data analysis agents, and/or meeting summarization tools, among other examples. These default templates may be designed to align with industry best practices and may be regularly updated to incorporate new features or optimizations. Users may have the ability to customize these default templates to better suit their specific organizational needs, while still benefiting from the pre-configured baseline settings.

In some implementations, the AI function management platform may allow users to create and submit their own deployment templates for personal or public use. User-created templates may be saved within the organization's private template library for reuse across different projects or departments. Additionally, the AI function management platform may feature a marketplace or community platform where users can share their custom deployment templates with the broader user base. This collaborative approach may foster innovation and knowledge sharing, enabling organizations to leverage diverse expertise and accelerate their AI deployment processes.

By providing these comprehensive tools for creating, testing, and deploying AI agents, the implementations described in this disclosure offers a powerful solution for organizations seeking to leverage AI technology effectively. The user-friendly interfaces and visual tools democratize AI development, enabling users with varying levels of technical expertise to create sophisticated AI competencies. This approach can lead to increased innovation, improved efficiency, and a competitive advantage in an increasingly AI-driven business landscape.

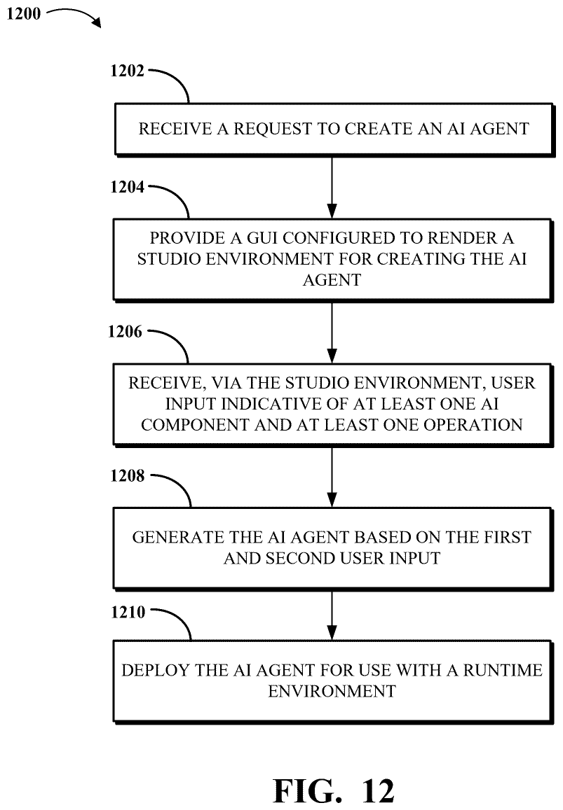

To further describe some implementations in greater detail, reference is next made to examples of techniques which may be performed by or using a system for managing AI functions. FIG. 12 is a flowchart of an example of a technique 1200 for creating and deploying an AI agent. The technique 1200 can be executed using computing devices, such as the systems, hardware, and software described with respect to FIGS. 1-11. The technique 1200 can be performed, for example, by executing a machine-readable program or other computer-executable instructions, such as routines, instructions, programs, or other code. The steps, or operations, of the technique 1200, or another technique, method, process, or algorithm described in connection with the implementations disclosed herein can be implemented directly in hardware, firmware, software executed by hardware, circuitry, or a combination thereof.

For simplicity of explanation, the technique 1200 is depicted and described herein as a series of steps or operations. However, the steps or operations of the technique 1200 can occur in various orders and/or concurrently. Additionally, other steps or operations not presented and described herein may be used. Furthermore, not all illustrated steps or operations may be required to implement a technique in accordance with the disclosed subject matter.

At 1202, a request to create an AI agent is received. This step may involve a user initiating the process of creating a new AI agent through a user interface or an automated system triggering the creation based on predefined conditions. In some implementations, a request is not received. Instead, an interface may be instantiated, an application started, and/or any other action taken to initiate an AI agent creating process.

At 1204, a GUI configured to render a studio environment for creating the AI agent is provided. The studio environment may include a drag-and-drop visual workflow builder that allows users to connect operations across multiple functional components from a set of available functional components. In some implementations, the visual workflow builder includes selectable nodes representing different functional components of the set of available functional components. In some implementations, the visual workflow builder includes selectable nodes representing different data sources of a set of available data sources.

At 1206, user input indicative of at least one AI component of the set of available functional components and at least one operation for performance by the at least one AI component is received via the studio environment. In some implementations, the user input includes at least one of a selection of one or more functional components of the set of available functional components or a configuration of one or more parameters associated with the at least one operation. In some implementations, the user input is associated with an arrangement of one or more visual components representing one or more AI components, including the at least one AI component. In some implementations, the at least one AI component includes at least one of a natural language processing component, an image recognition component, a speech-to-text conversion component, or an ML model component.

At 1210, the AI agent is generated based on the user input. Generating the AI agent may include translating the user-defined workflow and configurations into an executable AI agent, potentially leveraging various ML models and algorithms to generate the underlying code and logic. The AI agent may be generated using various approaches and techniques, depending on the specific requirements and complexity of the agent. In some cases, the AI function management platform may employ a code generation approach, where the user-defined workflow and configurations are translated into executable code using predefined templates and libraries. In some implementations, the AI function management platform may utilize ML techniques to optimize the generated code based on performance metrics and user feedback. In some implementations, the AI agent generation process may involve assembling pre-built components and customizing them according to the user's specifications. The AI function management platform may leverage natural language processing capabilities to interpret user inputs and generate appropriate code structures. In some implementations, the AI agent generation process may incorporate transfer learning techniques, allowing the system to adapt pre-trained models to specific use cases. In some implementations, the generation process may include automated testing and validation steps to ensure the AI agent meets predefined quality and performance standards before deployment.

In some implementations, the technique 1200 further includes grounding the AI agent with organizational data, wherein the organizational data includes at least one of a data vocabulary, a document, or a guideline. Grounding the AI agent may include receiving, via the studio environment, a selection of an organizational data source; and incorporating the selected organizational data source into the AI agent to enhance a contextual relevance of an output of the AI agent.

At 1212, the AI agent is deployed to a runtime environment. The runtime environment may be designed to scale dynamically based on demand, ensuring optimal performance and resource utilization. In some implementations, the technique 1200 further includes monitoring performance of the deployed AI agent; collecting feedback on the AI agent; and adjusting the AI agent based on at least one of the monitored performance or the collected feedback. In some implementations, the technique 1200 further includes collecting feedback on the AI agent; automatically refining one or more parameters of the AI agent based on the feedback; and redeploying the adjusted AI agent to the runtime environment.

Some implementations include a method, comprising: providing a graphical user interface configured to render a studio environment for creating an AI agent, wherein the studio environment comprises a drag-and-drop visual workflow builder for connecting operations across multiple functional components of a set of available functional components; receiving, via the studio environment, user input indicative of at least one AI component of the set of available functional components and at least one operation of the operations for performance by the at least one AI component; generating the AI agent based on the user input; and deploying the AI agent for use with a runtime environment.

In some implementations, the user input includes at least one of a selection of one or more functional components of the set of available functional components or a configuration of one or more parameters associated with the at least one operation.

In some implementations, the visual workflow builder includes selectable nodes representing different functional components of the set of available functional components.

In some implementations, the visual workflow builder includes selectable nodes representing different data sources of a set of available data sources.

In some implementations, the method further comprises: grounding the AI agent with organizational data, wherein the organizational data includes at least one of a data vocabulary, a document, or a guideline, and wherein grounding the AI agent comprises: receiving, via the studio environment, a selection of an organizational data source; and incorporating the selected organizational data source into the AI agent to enhance a contextual relevance of an output of the AI agent.

In some implementations, the method further comprises: monitoring performance of the AI agent; collecting feedback on the AI agent; and refining the AI agent based on at least one of the monitored performance or the collected feedback.

In some implementations, the method further comprises: collecting feedback on the AI agent; automatically refining one or more parameters of the AI agent based on the feedback; and redeploying the refined AI agent to the runtime environment.

In some implementations, the user input is associated with an arrangement of one or more visual components representing one or more AI components, including the at least one AI component.

In some implementations, the method further comprises: accessing organizational data to ground the AI agent, wherein generating the AI agent comprises generating executable code for the AI agent based on the user input and the organizational data; receiving a request to perform a task using the AI agent; executing, based on the request, the AI agent to generate an output; and providing the output to a client device.

In some implementations, the at least one AI component comprises at least one of a natural language processing component, an image recognition component, a speech-to-text conversion component, or a machine learning model component.

Some implementations include a non-transitory computer-readable medium storing instructions operable to cause one or more processors to perform operations comprising: providing a graphical user interface configured to render a studio environment for creating an artificial intelligence (AI) agent, wherein the studio environment comprises a drag-and-drop visual workflow builder for connecting operations across multiple functional components of a set of available functional components; receiving, via the studio environment, user input indicative of at least one AI component of the set of available functional components and at least one operation of the operations for performance by the at least one AI component; generating the AI agent based on the user input; and deploying the AI agent for use with a runtime environment.

In some implementations, the operations further comprise: monitoring performance metrics of the AI agent in the runtime environment; collecting user feedback on the AI agent; and automatically adjusting at least one parameter of the AI agent based on at least one of the performance metrics or the user feedback.

In some implementations, the operations further comprise: identifying an underperforming component of the AI agent; modifying a configuration of the underperforming component; and redeploying the AI agent with the modified configuration.

In some implementations, the operations further comprise implementing role-based access controls for the AI agent, wherein the role-based access controls define permissions associated with the AI agent based on user roles within an organization, the permissions comprising at least one of a permission for creating the AI agent, a permission for editing the AI agent, or a permission for executing the AI agent.

In some implementations, the operations further comprise: determining a role associated with a user corresponding to the user input; and determining, based on the role, a role profile associated with one or more AI functions, wherein the AI agent is based at least in part on the role profile.

In some implementations, the set of available functional components comprises at least one enterprise software service, the at least one enterprise software service comprising at least one of an email service, a calendar service, a conferencing service, an instant messaging service, a document generation service, or a database service.

Some implementations include a system, comprising: a memory subsystem storing instructions; and processing circuitry configured to execute the instructions to cause the system to: provide a graphical user interface configured to render a studio environment for creating an artificial intelligence (AI) agent, wherein the studio environment comprises a drag-and-drop visual workflow builder for connecting operations across multiple functional components of a set of available functional components; receive, via the studio environment, user input indicative of at least one AI component of the set of available functional components and at least one operation of the operations for performance by the at least one AI component; generate the AI agent based on the user input; and deploy the AI agent for use with a runtime environment.

In some implementations, the visual workflow builder includes a set of selectable nodes representing at least one of an AI component of the at least one AI component, a data source, an integration with an enterprise software service, an integration with a local application, or an integration with an external application.

In some implementations, the processing circuitry is further configured to execute the instructions to cause the system to generate the AI agent by generating source code corresponding to the AI agent.

In some implementations, the processing circuitry is further configured to execute the instructions to cause the system to: determine a role associated with a user corresponding to the user input; determine, based on the role, a role profile associated with one or more AI functions; and automatically refine parameters of the AI agent based on the role profile.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
providing a graphical user interface configured to render a studio environment for creating an artificial intelligence (AI) agent, wherein the studio environment comprises a drag-and-drop visual workflow builder for connecting operations across multiple functional components of a set of available functional components;
receiving, via the studio environment, user input indicative of at least one AI component of the set of available functional components and at least one operation of the operations for performance by the at least one AI component;
generating the AI agent based on the user input; and
deploying the AI agent for use with a runtime environment.

2. The method of claim 1, wherein the user input includes at least one of a selection of one or more functional components of the set of available functional components or a configuration of one or more parameters associated with the at least one operation.

3. The method of claim 1, wherein the visual workflow builder includes selectable nodes representing different functional components of the set of available functional components.

4. The method of claim 1, wherein the visual workflow builder includes selectable nodes representing different data sources of a set of available data sources.

5. The method of claim 1, further comprising:
grounding the AI agent with organizational data, wherein the organizational data includes at least one of a data vocabulary, a document, or a guideline, and wherein grounding the AI agent comprises:
receiving, via the studio environment, a selection of an organizational data source; and
incorporating the selected organizational data source into the AI agent to enhance a contextual relevance of an output of the AI agent.

6. The method of claim 1, further comprising:
monitoring performance of the AI agent;
collecting feedback on the AI agent; and
refining the AI agent based on at least one of the monitored performance or the collected feedback.

7. The method of claim 1, further comprising:
collecting feedback on the AI agent;
automatically refining one or more parameters of the AI agent based on the feedback; and
redeploying the refined AI agent to the runtime environment.

8. The method of claim 1, wherein the user input is associated with an arrangement of one or more visual components representing one or more AI components, including the at least one AI component.

9. The method of claim 1, further comprising:
accessing organizational data to ground the AI agent, wherein generating the AI agent comprises generating executable code for the AI agent based on the user input and the organizational data;
receiving a request to perform a task using the AI agent;
executing, based on the request, the AI agent to generate an output; and
providing the output to a client device.

10. The method of claim 1, wherein the at least one AI component comprises at least one of a natural language processing component, an image recognition component, a speech-to-text conversion component, or a machine learning model component.

11. A non-transitory computer-readable medium storing instructions operable to cause one or more processors to perform operations comprising:
providing a graphical user interface configured to render a studio environment for creating an artificial intelligence (AI) agent, wherein the studio environment comprises a drag-and-drop visual workflow builder for connecting operations across multiple functional components of a set of available functional components;
receiving, via the studio environment, user input indicative of at least one AI component of the set of available functional components and at least one operation of the operations for performance by the at least one AI component;
generating the AI agent based on the user input; and
deploying the AI agent for use with a runtime environment.

12. The non-transitory computer readable medium of claim 11, wherein the operations further comprise:
monitoring performance metrics of the AI agent in the runtime environment;
collecting user feedback on the AI agent; and
automatically adjusting at least one parameter of the AI agent based on at least one of the performance metrics or the user feedback.

13. The non-transitory computer readable medium of claim 11, wherein the operations further comprise:
identifying an underperforming component of the AI agent;
modifying a configuration of the underperforming component; and
redeploying the AI agent with the modified configuration.

14. The non-transitory computer readable medium of claim 11, wherein the operations further comprise:
implementing role-based access controls for the AI agent, wherein the role-based access controls define permissions associated with the AI agent based on user roles within an organization, the permissions comprising at least one of a permission for creating the AI agent, a permission for editing the AI agent, or a permission for executing the AI agent.

15. The non-transitory computer readable medium of claim 11, wherein the operations further comprise:
determining a role associated with a user corresponding to the user input; and
determining, based on the role, a role profile associated with one or more AI functions, wherein the AI agent is based at least in part on the role profile.

16. The non-transitory computer readable medium of claim 11, wherein the set of available functional components comprises at least one enterprise software service, the at least one enterprise software service comprising at least one of an email service, a calendar service, a conferencing service, an instant messaging service, a document generation service, or a database service.

17. A system, comprising:
a memory subsystem storing instructions; and
processing circuitry configured to execute the instructions to cause the system to:
provide a graphical user interface configured to render a studio environment for creating an artificial intelligence (AI) agent, wherein the studio environment comprises a drag-and-drop visual workflow builder for connecting operations across multiple functional components of a set of available functional components;
receive, via the studio environment, user input indicative of at least one AI component of the set of available functional components and at least one operation of the operations for performance by the at least one AI component;
generate the AI agent based on the user input; and
deploy the AI agent for use with a runtime environment.

18. The system of claim 17, wherein the visual workflow builder includes a set of selectable nodes representing at least one of an AI component of the at least one AI component, a data source, an integration with an enterprise software service, an integration with a local application, or an integration with an external application.

19. The system of claim 17, wherein the processing circuitry is further configured to execute the instructions to cause the system to generate the AI agent by generating source code corresponding to the AI agent.

20. The system of claim 19, wherein the processing circuitry is further configured to execute the instructions to cause the system to:
determine a role associated with a user corresponding to the user input;
determine, based on the role, a role profile associated with one or more AI functions; and
automatically refine parameters of the AI agent based on the role profile.
